(19) United States
(12) Patent Application Publication
(10) Pub. No.: US 2025/0330851 A1
(43) Pub. Date: Oct. 23, 2025

(54) NETWORK CONNECTION MAPPING USING TRANSPORTERS

(71) Applicant: DoorDash, Inc., San Francisco, CA (US)

(72) Inventors: Sushil Vellanki, Dublin, CA (US); Jeyda Kaynatma, Oakland, CA (US); Karthikeyan Velayutham, Antioch, CA (US); Xun Liu, San Jose, CA (US); Gayatri Iyengar, Cupertino, CA (US)

(73) Assignee: DoorDash, Inc., San Francisco, CA (US)

(21) Appl. No.: 19/175,272

(22) Filed: Apr. 10, 2025

Related U.S. Application Data
(60) Provisional application No. 63/635,883, filed on Apr. 18, 2024.

(51) Int. Cl. H04W 24/08; H04W 4/024

(52) U.S. Cl. CPC H04W 24/08; H04W 4/024

(57) ABSTRACT

A method is disclosed. The method includes receiving transporter data associated with a plurality of transporters. The transporter data comprises time and location data of the transporters at time intervals as the transporters deliver items to end users. The method also includes creating a network connectivity map based upon the transporter data, and then storing the network connectivity map. The network connectivity map is then used to assist other transporters when transporting items.

### CROSS-REFERENCE TO RELATED APPLICATIONS

This application is a non-provisional application of and claims the benefit of U.S. provisional application No. 63/635,883, filed on Apr. 18, 2024, which is herein incorporated by reference in its entirety for all purposes.

### BRIEF SUMMARY

Embodiments of the present disclosure are directed towards methods and systems for collecting transporter data at regular intervals in order to determine a network connectivity map. The volume transporter data that is received by a central server computer at a particular location can indicate the quality of network connectivity at that location. A good network connection may be characterized by transporter data being received by a server computer at regular intervals, whereas a poor network connection may be characterized by transporter data being received by a server computer at irregular intervals, or not at all. Embodiments can use the network connectivity map to address areas along transport routes with poor network connectivity. The transport routes can be routes to deliver items to end users, or to deliver the end users themselves to intended destinations.

One embodiment includes a method comprising: receiving, by a server computer, transporter data associated with a plurality of transporters, wherein the transporter data comprises time and location data of the transporters at time intervals as the transporters move; and creating, by the server computer, a network connectivity map based upon the transporter data; and storing, by the server computer, the network connectivity map.

Another embodiment of the invention includes a server computer comprising: a processor; and a non-transitory computer readable medium coupled to the processor, the non-transitory computer readable medium coupled to the processor, the non-transitory computer readable medium comprising code, executable by the processor for performing a method comprising: receiving transporter data associated with a plurality of transporters, wherein the transporter data comprises time and location data of the transporters at time intervals as the transporters move; creating a network connectivity map based upon the transporter data; and storing the network connectivity map.

Prior to describing embodiments in more detail, it may be helpful to review some terms used throughout this disclosure.

### TERMS

A “server computer” may refer to a computer or cluster of computers. A server computer may be a powerful computing system, such as a large mainframe. Server computers can also include minicomputer clusters or a group of servers functioning as a unit. In one example, a server computer can include a database server coupled to a web server. A server computer may comprise one or more computational apparatuses and may use any of a variety of computing structures, arrangements, and compilations for servicing requests from one or more client computers.

A “user” may refer to an entity that uses something for some purpose. An example of a user is a person who uses a “user device” (e.g., a smartphone, wearable device, laptop, tablet, desktop computer, etc.). Another example of a user is a person who uses some service, such as a person who uses a delivery service, a member of an online video streaming service, a person who uses a tax preparation service, a person who receives healthcare from a hospital or other organization, etc. A user may be associated with “user data,” data which describes the user or their use of something (e.g., their use of a user device or a service). In some circumstances, a user may be referred to as an “end user.”

A “user device” may be any suitable electronic device that can be used by a user. An exemplary user device can process and communicate information to other electronic devices. The user device may include a processor and a computer-readable medium coupled to the processor, the computer-readable medium comprising code, executable by the processor. The user device may also each include an external communication interface for communicating with other entities. Examples of user devices may include mobile devices such as mobile phones and laptop computers, wearable devices (e.g., glasses, rings, watches, etc.), hardware modules in larger devices such as vehicles (e.g., automobiles), etc.

A “transporter” can be an entity that transports something. For example, a transporter can be a person that transports an item using a transporter vehicle (e.g., a car). In other embodiments, a transporter can be a transporter vehicle that may or may not be operated by a human. Examples of transporter vehicles include cars, boats, scooters, bicycles, drones, airplanes, etc. Transporters can also include autonomous vehicles such as self driving cars and unmanned drones.

A “fulfillment request” can be a request to provide a resource in response to the fulfillment request. For example, a fulfillment request can include an initial communication from an end user device to a central server computer for a first service provider computer to fulfill a purchase request for a resource, e.g., a purchase request for food from a restaurant. A fulfillment request can include one or more selected items from a selected service provider. A fulfillment request can also include user features of the end user providing the fulfillment request.

An “item” can include an individual article or unit. An item can be a thing that is provided by a service provider. Items can be goods, For example, bowls of soup, soda cans, toys, clothing, etc. An item can be delivered from a service provider location to an end user location by a transporter.

A “feature” can be an individual measurable property or characteristic of a phenomenon. One or more features can be described using a “feature vector,” e.g., a structured list of data (such as numerical data) representing those features. A feature can be input into a model to determine an output. As an example, in pattern recognition and machine learning, a feature vector can comprise an n-dimensional vector of numerical features that represent some object. In some machine learning contexts, a numerical representation of objects facilitate processing and statistical analysis. For image processing, for example, feature values might correspond to the pixels of an image. As another example, when feature vectors represent text, the features may comprise occurrence frequency of textual terms. Feature vectors can be equivalent to the vectors of explanatory variables used in statistical procedures such as linear regression.

The term “artificial intelligence model” or “machine learning model” can include a model that may be used to predict outcomes to achieve a pre-defined goal. A machine learning model may be developed using a learning process, in which training data is classified based on known or inferred patterns.

“Machine learning” can include an artificial intelligence process in which software applications may be trained to make accurate predictions through learning. The predictions can be generated by applying input data to a predictive model formed from performing statistical analyses on aggregated data. A model can be trained using training data, such that the model may be used to make accurate predictions. The prediction can be, for example, a classification of an image (e.g., identifying images of cats on the Internet) or as another example, a recommendation (e.g., a movie that a user may like or a restaurant that a consumer might enjoy).

A “machine learning model” may include an application of artificial intelligence that provides systems with the ability to automatically learn and improve from experience without explicitly being programmed. A machine learning model may include a set of software routines and parameters that can predict an output of a process (e.g., identification of an attacker of a computer network, authentication of a computer, a suitable recommendation based on a user search query, etc.) based on feature vectors or other input data. A structure of the software routines (e.g., number of subroutines and the relation between them) and/or the values of the parameters can be determined in a training process, which can use actual results of the process that is being modeled, e.g., the identification of different classes of input data. Examples of machine learning models include support vector machines (SVM), models that classify data by establishing a gap or boundary between inputs of different classifications, as well as neural networks, collections of artificial “neurons” that perform functions by activating in response to inputs. A machine learning model can be trained using “training data” (e.g., to identify patterns in the training data) and then apply this training when it is used for its intended purpose. A machine learning model may be defined by “model parameters,” which can comprise numerical values that define how the machine learning model performs its function. Training a machine learning model can comprise an iterative process used to determine a set of model parameters that achieve the best performance for the model. One example of a machine learning model is an unsupervised learning model. Another example type of model is supervised learning that can be used with embodiments of the present disclosure. Example supervised learning models may include different approaches and algorithms including analytical learning, statistical models, artificial neural network, backpropagation, boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), random forests, ensembles of classifiers, ordinal classification, data pre-processing, handling imbalanced datasets, statistical relational learning, or Proaftn, a multicriteria classification algorithm. The model may include linear regression, logistic regression, deep recurrent neural network (e.g., long short term memory, LSTM), hidden Markov model (HMM), linear discriminant analysis (LDA), k-means clustering, density-based spatial clustering of applications with noise (DBSCAN), random forest algorithm, support vector machine (SVM), or any model described herein. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

A “memory” may refer to any suitable device or devices that may store electronic data. A suitable memory may comprise a non-transitory computer readable medium that stores instructions that can be executed by a processor to implement a desired method. Examples of memories including one or more memory chips, disk drives, etc. Such memories may operate using any suitable electrical, optical, and/or magnetic mode of operation.

A “processor” may refer to any suitable data computation device or devices. A processor may comprise one or more microprocessors working together to achieve a desired function. The processor may include a CPU that comprises at least one high-speed data processor adequate to execute program components for executing user and/or system generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xenon, and/or Xscale; and/or the like processor(s).

### BRIEF DESCRIPTION OF THE DRAWINGS

FIG. 1 shows a block diagram of a system according to some embodiments.

FIG. 2 shows a block diagram of a central server computer 102 according to embodiments.

FIG. 3 shows a flow diagram illustrating an exemplary preparation and delivery method according to embodiments.

FIG. 4 shows a flow diagram illustrating an exemplary preparation and delivery method according to embodiments.

FIG. 5 shows a flow diagram illustrating transporter data collection and processing according to embodiments.

FIG. 6 shows several timelines associated with different transporter and service provider timings relating to hypothetical item fulfillment requests.

FIG. 7 shows transporter location data points overlaid on a map, and a corresponding timeline representing the volume transporter data points per minute.

FIG. 8 shows ping data collected from transporter user devices during transportation to a particular location along with an amount of time spent at the particular location.

FIG. 9 includes shows ping data collected from transporter user devices during transportations along with a total number of times that the transporters restarted their applications and restart rates.

### DETAILED DESCRIPTION

Transporters are used in a variety of situations to transport items or people. When transporters travel between locations to transport items or people, they need to be continuously connected to communication networks such as cellular networks. Unfortunately, network connectivity quality can be strong in some areas, but weak in others. This can present a number of problems and can make the transportation of items or people more difficult and time consuming.

An illustration can be provided with respect to an item fulfillment service. In an item fulfillment service (e.g., a delivery service), service providers can prepare items for end users upon receiving fulfillment requests from the end users. These items can be retrieved by transporters who can then transport the items from the service providers that produced them to their end users.

When a transporter is unable to connect to a network such as a cellular network, the transporter may be delayed in delivering an item to a requesting end user. For example, if the transporter is unable to connect to a network, the transporter may not be capable of receiving any updated information regarding the delivery of the item. As an illustration, a message to change a delivery address may be transmitted to a transporter user device operated by the transporter when the transporter is in a location with poor network connectivity during transportation. The transporter may not receive the message in a timely manner and will consequently deliver the item to the wrong location. The transporter will need to spend additional time transporting the item to the updated location after the transporter reaches a location with a good network connection and is able to review the updated address information. In another example, during the transportation of items or people, the transporter may use a user device with an application to communicate with a central server computer to receive transportation instructions. If the transporter is in an area with poor network connectivity, the application on the transporter user device may be slow or may appear to be inoperative. This transporter may believe that something is wrong with the application and may restart it, even though there is nothing wrong with the application. This will cause additional delays in the transportation provided by the transporters. In yet another example, if the transporter is in an area where the network connectivity is poor, then the transporter will be unable to effectively communicate with the central server computer supporting the application on the transporter's user device. The transporter may not receive location information in a timely manner thereby increasing the time for any pickup and drop off performed by the transporter. The transporter may be unable to communicate with the end user and/or the central server computer during transportation. The inability to communicate will result in the transporter spending more time during transportation. If the transporter is an autonomous vehicle and is receiving control signals from a central server computer, then the inability of the autonomous vehicle to effectively communicate with the central server computer may result in the autonomous vehicle being delayed or damaged.

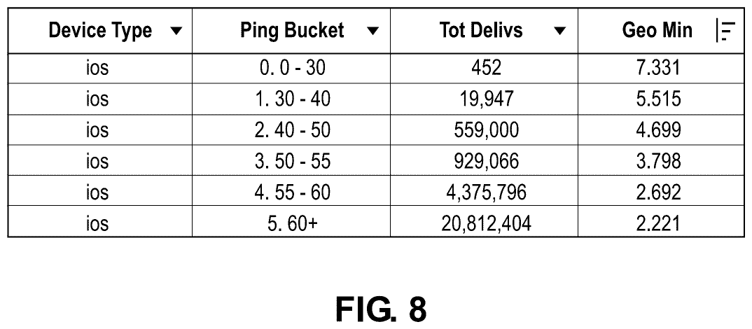

To illustrate, FIG. 8 shows data collected from transporter user devices during transportations. Transporter user devices were configured to regularly transmit transporter data, or send “pings” to a server computer throughout the transportations.

In general, the amount of pings that are sent may be limited by factors such as device type. For example, each minute, each transporter user device that is an ios device type can transmit a total of 60 pings. Assuming that the network connection is good, the server computer should receive the 60 pings each minute. However, if there is weak or non-existent network then the pings may not be received by the server computer, and the volume of pings transmitted in a given minute may be less than 60. Thus, the volume of pings per minute can be an indicator of network connectivity quality.

The table in FIG. 8 reflects data from when the transporters are at drop-off locations. The table illustrates that transporters spend more time at drop-off locations with poor network connectivity.

A plurality of deliveries is sorted based on the volume of pings received when the transporter is at the drop-off location associated with the transportation. As shown, for 20,812,404 deliveries, 60 pings per minute (or more) were received by the transporter user devices at the drop-off locations. Accordingly, the quality of network connectivity of the drop-off locations for the 20,812,404 deliveries is good. The average time spent at the drop-off locations for the 20,812,404 deliveries is 2.221 minutes.

Comparatively, for the 452 deliveries that are associated with 30 or less pings per minute at the drop-off locations, the average time spent at the drop-off locations is 7.331 minutes. When there is poor network connectivity, as indicated by the 30 or less pings per minute, the transporters spend more time, on average, at the drop-off location than when there is good network connectivity (e.g., 60 or more pings per minute).

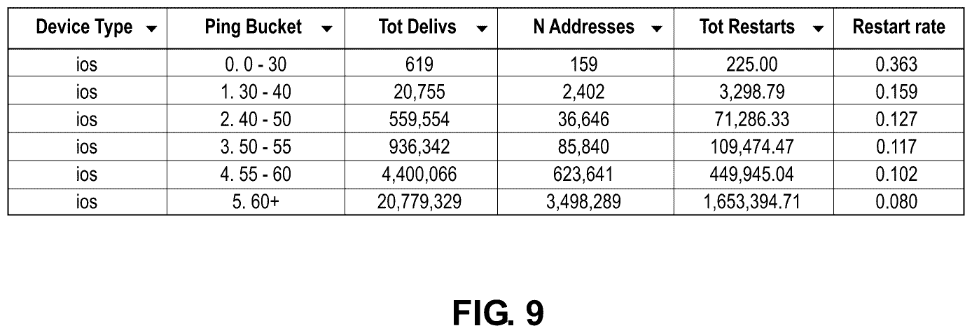

The data also shows, for each delivery, how many times the transporter restarted the application used to communicate with the central server computer. FIG. 9 includes a total number of times that the transporters restarted their applications and restart rates, which can be the total number of times that the transporters restarted the application in comparison to the total number of deliveries for that ping bucket. For 20,779,329 deliveries associated with 60 or more pings per minute (60+ ping bucket), the restart rate is 0.08. For 619 deliveries associated with 30 or less pings per minute (0-30 ping bucket), the restart rate is 0.363.

As previously described, 30 or less pings per minute from an ios device can indicate that the network connectivity is poor, since it is at most half the desired volume. Together, FIG. 8 and FIG. 9 indicate that poor network connectivity may be correlated with transporters spending more time at drop-off locations and an increased restart rate.

For the reasons described above, it is desired to identify areas with poor network connections, so that additional actions can be taken to minimize the adverse effects of them. Mobile network operators have maps of network coverage. However, requesting network coverage information from mobile network operators are often inaccurate and imprecise. For example, a network service provider may only provide network coverage levels by zip code, and are not granular enough to be of use to transporters or central server computers that communicate with transporters. Further, environment specific factors such as atmospheric conditions and physical obstacles (e.g., elevators, buildings, garages, etc.) may impact network connection in specific areas.

To address these and other problems, embodiments can determine a network connectivity map based on transporter data. In embodiments of the disclosure, a server computer can receive transporter data associated with a plurality of transporters. The transporter data may comprise time and location data (e.g., GPS location data) of the transporter data as the transporters perform transportation.

To illustrate, the server computer can check the network status of the transporter user device by collecting transporter location data at a regular interval throughout a delivery or other transport process. The server computer can aggregate the location data by a specified interval (e.g., data points per minute). If the aggregated transporter location data indicates consistent responses to the network status checks, the network connectivity may be strong. If it does not indicate consistent responses (e.g., responds only sometimes), the network connectivity may be intermittent or weak. If the transporter user device does not respond to the network status checks, then there is no network connectivity.

In some embodiments, the server computer can input the transporter data into a machine learning model to create a network connectivity map that predicts the network coverage of an area. In some embodiments, the machine learning model may utilize features such as the identity of the network service provider of the transporter user device and the device type of the transporter user device.

Embodiments can provide insight into service provider addresses, delivery addresses, and delivery routes with poor network connectivity. With this information, if a transporter delivering an item is about to enter an area that, according to the network connectivity map, is known to have poor network connectivity, embodiments can take steps to minimize the impact of the area with poor network connectivity. For example, a central server computer directing the transporter can provide a message to the transporter. The message can comprise information about cellular connectivity at one or more locations along a pickup route from a current location of the transporter to a location of the service provider, or one or more locations along a delivery route from the location of the service provider to a location of the end user. The transporter can then be informed, in advance, about the areas with poor network connectivity and can either anticipate that communication in those areas will be poor or can take some alternative action (e.g., attempt to look for a local Wi-Fi™ signal). In some embodiments, an automated process can be initiated if the transporter enters an area with poor network connectivity. For example, if the transporter enters an area with poor cellular network connectivity, a central server computer can transmit a message comprising code that causes the transporter user device to automatically improve communication between the transporter user device and the server computer, such as by automatically connecting the transporter's end user device to an available Wi-Fi™ network at the location with poor cellular network connectivity.

In some embodiments, before the transporter enters a location with poor network connectivity, as determined by the network connectivity map, the server computer can transmit a message to the transporter user device to download (e.g., automatically) navigation information (e.g., map data, instructions) to the transporter user device. As a result, when the transporter enters the location with poor network connectivity, the navigation services can utilize the downloaded navigation information in an offline manner, so that the transporter can continue transporting in spite of the poor network connectivity. For example, if the transporter is an autonomous vehicle, it can use a local routing mechanism (e.g., an offline map) to automatically route it, until it is back in an area of strong network connectivity. When it is in an area of strong network connectivity, it can be routed and controlled by the server computer according to the route which it is supposed to travel.

In some embodiments, the central server computer can create, maintain, and store separate network connectivity maps for different network service providers and/or transporter user device types. Some network service providers may offer better coverage in some regions than others, and thus the network connectivity may vary depending on the network service provider of the transporter user device. Moreover, some device types may have privacy restrictions that limit the frequency that transporter data may be transmitted to the server computer, while others may not. Different device types may also have different connectivity characteristics.

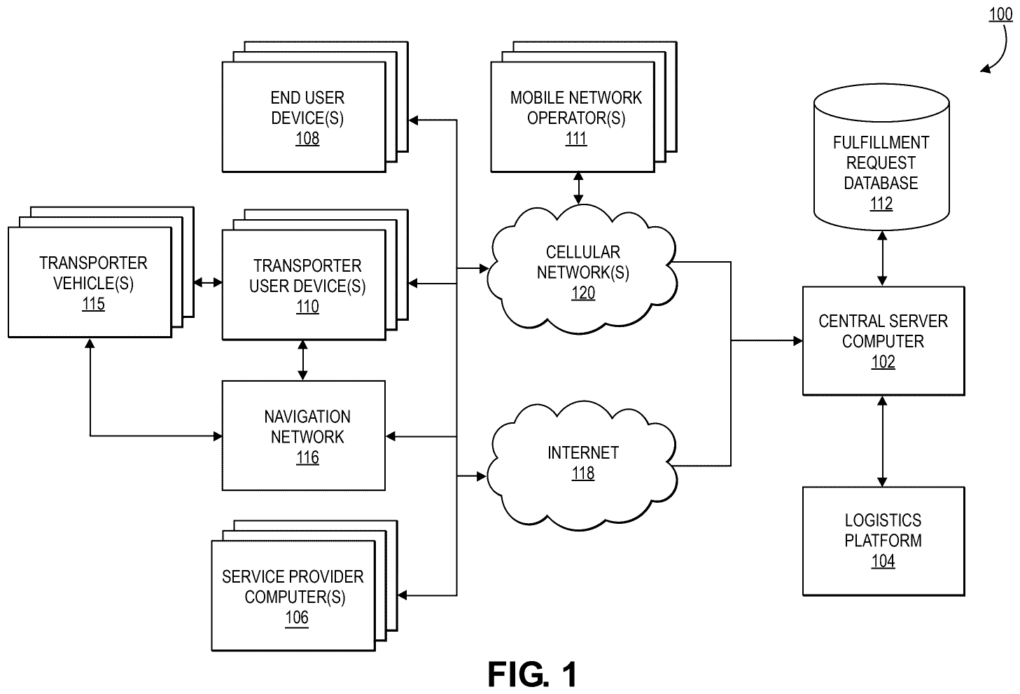

FIG. 1 shows a system 100 according to some embodiments of the present disclosure. The system 100 can comprise one or more end user devices 108, a central server computer 102, a fulfillment request database 112, a logistics platform 104, one or more transporter user devices 110, one or more service provider computers 106, a navigation network 116, the Internet 118, one or more cellular networks 120, and one or more mobile network operators 111. FIG. 1 also shows one or more transporter vehicles 115, which may be operated by “transporters”, e.g., users of the transporter user devices 110. As an example, a transporter can be a delivery person, a transporter user device 110 can comprise that delivery person's mobile phone, and a transporter vehicle 115 can be a car that is operated by the delivery person.

For simplicity of illustration, a certain number of components are shown in FIG. 1. It should be understood, however, that embodiments of the present disclosure may include more than one of each component. In addition, some systems according to embodiments of the present disclosure may include a lesser number of components or a greater number of components than those shown in FIG. 1.

The central server computer 102 can be in operative communication with the one or more end user devices 108, the fulfillment request database 112, the logistics platform 104, the one or more service provider computers 106, the transporter user device 110, and in some embodiments, the navigation network 116. Further, the one or more transporter user devices 110 can be in operative communication with the navigation network 116. These devices and computers can communicate with one another by sending messages over the one or more cellular networks 120 or the internet 118, or both. Messages between at the devices in system 100 can be transmitted using a secure communications protocol such as, but not limited to, File Transfer Protocol (FTP); HyperText Transfer Protocol (HTTP); Secure Hypertext Transfer Protocol (HTTPS), SSL, and/or the like.

In more detail, the one or more end user devices 108 can include devices operated by end users. The one or more end user devices 108 can generate and provide fulfillment request messages to the central server computer 102. A fulfillment request message can indicate that a request (e.g., a request for a service, or a request for an item, such as a meal to be delivered) can be fulfilled by one or more service providers operating the one or more service provider computers 106.

The central server computer 102 can facilitate the fulfillment of fulfillment requests received from the one or more end user devices 108. For example, the central server computer 102 can identify a transporter, corresponding to a transporter user device 110 that can satisfy the fulfillment request based on any suitable criteria (e.g., transporter location, service provider location, end user destination, end user location, transporter mode of transportation, etc.). The logistics platform 104 may provide real time data regarding locations of the various service providers, transporters, and end users to the central server computer 102.

The fulfillment request database 112 can store data related to previous (e.g., historical) fulfillment requests. For example, after a fulfillment request is fulfilled, the central server computer 102 can store fulfillment request data in the fulfillment request database 112. For example, the central server computer 102 can store any spatial-temporal fulfillment data (e.g., transporter user device locations over time, transporter user device motion data over time, length of time taken to fulfill the fulfillment request, a fulfillment time, a fulfillment location, etc.), fulfillment service data (e.g., fulfilled services, an amount, a service provider computer identifier, an end user device identifier, a transporter user device identifier, etc.), and any other data relating to the fulfillment request and/or the fulfillment of the fulfillment request.

The one or more service provider computers 106 can include computers operated by service providers. For example, a service provider computer can be a food provider computer that is operated by a food provider (e.g., a restaurant, grocery store, convenience store, etc.). Service providers can use the one or more service provider computers 106 to offer to provide services to the end users of the one or more end user devices 108. A service provider computer 106 can receive requests to prepare one or more items for delivery from the central server computer 102. The service provider computer can initialize the preparation of the one or more items so that they can be delivered to an end user of an end user device 108 by a transporter user of a transporter user device 110.

The one or more transporter user devices 110 can be devices (e.g., computers) operated by transporters. As examples, the one or more transporter user devices 110 can be smartphones, wearable devices, personal assistant devices, etc. A transporter can request to fulfill an end user's fulfillment request. For example, the transporter user device 110 can generate and transmit a request to fulfill a particular end user's fulfillment request to the central server computer 102. The central server computer 102 can notify the transporter user device 110 of the fulfillment request. The transporter user device 110 can respond to the central server computer 102 with a request to perform the delivery to the end user as indicated by the fulfillment request.

The navigation network 116 can provide navigational directions to the one or more transporter user devices 110. For example, a transporter user device 110 can obtain a location from the central server computer 102. The location can be a service provider parking location, a service provider location, an end user parking location, an end user location, etc. The navigation network 116 can provide navigational data that can be used to navigate to the location. For example, the navigation network 116 can be a global positioning system that provides location data to the transporter user device 110.

The one or more mobile network operators 111 can provide mobile devices (e.g., end user devices 108 or transporter user devices 110) to users (e.g., end users and transporters), as well as provide access to the one or more cellular networks 120.

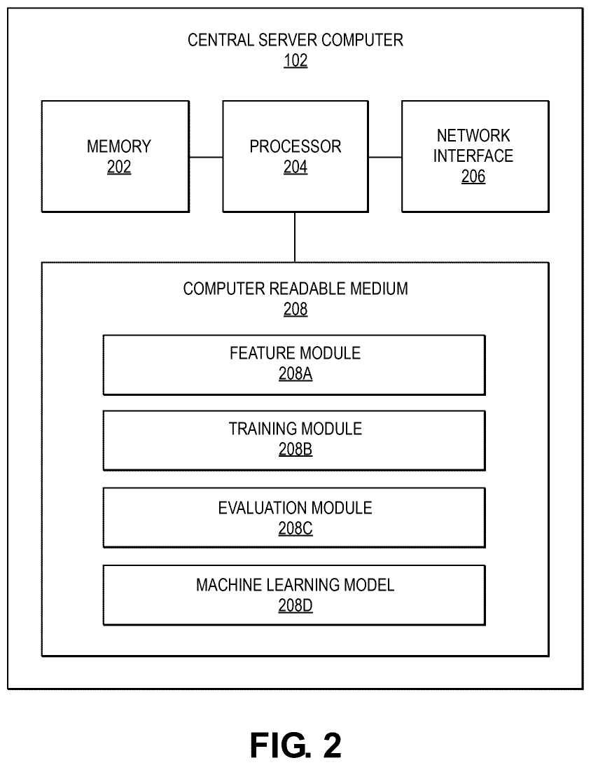

FIG. 2 shows a block diagram of a central server computer 102 according to embodiments. The central server computer 102 may comprise a processor 204. The processor 204 may be coupled to a memory 202, a network interface 206, and a computer readable medium 208. The computer readable medium 208 can comprise a feature module 208A, a training module 208B, an evaluation module 208C, and a machine learning module 208D.

The memory 202 can be used to store data and code. For example, the memory 202 can store input data, features, machine learning models, weights, etc. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The computer readable medium 208 may comprise code, executable by the processor 204, for performing a method comprising: receiving transporter data associated with a plurality of transporters, wherein the transporter data comprises time and location data of the transporters at time intervals as the transporters move; creating a network connectivity map based upon the transporter data; and storing the network connectivity map.

The feature module 208A may comprise code or software, executable by the processor 204, for determining and/or evaluating features. The feature module 208A, in conjunction with the processor 204, can extract features from a dataset. Example features may comprise GPS Feature extraction can start from an initial set of measured data (e.g., data from the dataset). The feature module 208A, in conjunction with the processor 204, can obtain the dataset from a memory or database. The feature module 208A, in conjunction with the processor 204, can build derived values (e.g., features) from the dataset that can be intended to be informative and non-redundant, facilitating the subsequent learning and generalization steps, and in some cases leading to better human interpretations. Feature extraction can be related to dimensionality reduction of the dataset.

The feature module 208A, in conjunction with the processor 204, can perform feature extraction/dimensionality reduction techniques including independent component analysis, isomap creation, principle component analysis, latent semantic analysis, partial least squares, multifactor dimensionality reduction, nonlinear dimensionality reduction, embedding, autoencoders, etc.

For example, the server computer may collect raw transporter data (e.g., transporter location and time) every second throughout a delivery. The feature module 208A may aggregate the data into a number associated with the volume of transporter data points received per minute.

The training module 208B can include may comprise code or software, executable by the processor 204, for training machine learning model(s). The process of training a machine learning model involves providing a machine learning algorithm with training data to learn from. The training module 208B, in conjunction with the processor 204, can input training data into the machine learning model for training. The training data can include labels that indicate the target attribute of the data.

The training module 208B, in conjunction with the processor 204, can aid the learning algorithm in finding patterns in the training data that map the input data attributes to the target. The training module 208B, in conjunction with the processor 204, can output a trained machine learning model that captures these patterns.

The training module 208B, in conjunction with the processor 204, can further train the trained machine learning model with additional training data that may be obtained after the initial training is complete. The training module 208B, in conjunction with the processor 204, can continuously train the trained machine learning model over time.

The evaluation module 208C can include may comprise code or software, executable by the processor 204, for evaluating data and machine learning model(s). The evaluation module 208C, in conjunction with the processor 204, can utilize the trained machine learning model to obtain predictions on new data for which the target (e.g., the predicted value and the predicted rank) are unknown. The evaluation module 208C, in conjunction with the processor 204, can input historical data (e.g., historical transporter data) into the trained machine learning model for evaluation. The trained machine learning model can output a network connectivity map.

The machine learning module 208D can include one or more machine learning models including neural networks, support vector machines, regression models etc.

The network interface 206 may include an interface that can allow the central server computer 102 to communicate with external computers. The network interface 206 may enable the central server computer 102 to communicate data to and from another device (e.g., the logistics platform 104, the one or more service provider computers 106, the end user device 108, the transporter user device 110, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

In some embodiments, the central server computer 102 may be in operative communication with one or more databases. For example, the central server computer 102 can communicate with a dataset database and/or a features database. The databases may be conventional, fault tolerant, relational, scalable, secure databases such as those commercially available from Oracle™ or Sybase™.

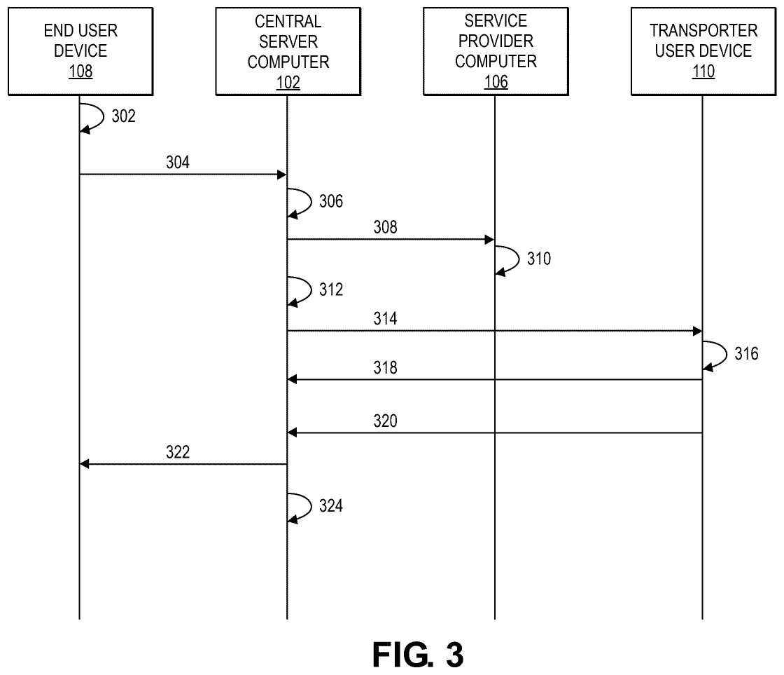

FIG. 3 shows a flow diagram illustrating a preparation and delivery method according to embodiments, wherein transporter data is collected. The method illustrated in FIG. 3 will be described in the context of the central server computer 102 receiving a fulfillment request message from the end user device 108 to fulfill preparation and delivery of one or more items from a cart to the end user of the end user device 108. The central server computer 102 can communicate with the service provider computer 106 and the transporter user device 110 to fulfill the fulfillment request and to collect transporter data.

At step 302, the end user device 108 can decide to check out with a cart in a central server computer application installed on the end user device 108. The cart can include one or more items that are provided from a service provider of the service provider computer 106.

At step 304, after checking out with the cart, the end user device 108 can provide a fulfillment request message including the one or more items from the cart to the central server computer 102. The fulfillment request message can also include a service provider computer identifier that identifies the service provider computer 106.

At step 306, after receiving the fulfillment request message, the central server computer 102 can perform a transaction process with the end user device 108. For example, the central server computer 102 can communicate with a payment network to process the transaction for the one or more items. The central server computer 102 can receive an indication of whether or not the transaction is authorized. If the transaction is authorized, then the central server computer 102 can proceed with step 308.

At step 308, the central server computer 102 can provide the fulfillment request message, or a derivation thereof, to the service provider computer 106. The central server computer 102 can determine which service provider computer of a plurality of service provider computers to communicate with based on the service provider indicated in the fulfillment request message. For example, the fulfillment request message can indicate that the one or more items are provided by the service provider of the service provider computer 106. The central server computer 102 can identify the service provider computer 106 using the service provider computer identifier in the fulfillment request message.

At step 310, after receiving the fulfillment request message, the service provider computer 106 can initiate preparation of the one or more items. For example, the service provider computer 106 can alert service providers (e.g., those preparing the items) at the service provider location. The service providers can prepare the one or more items for pick up by a transporter.

At step 312, after providing the fulfillment request message to the service provider computer 106, the central server computer 102 can determine one or more transporters operating one or more user devices that are capable of fulfilling the fulfillment request message. The central server computer 102 can determine the one or more transporters from the transporter user devices. The central server computer 102 can determine the one or more transporter user devices based on whether or not the transporter user device is online, whether or not the transporter user device is already fulfilling a different fulfillment request message, a location of the transporter user device, etc.

At step 314, after determining the one or more transporter user devices, the central server computer 102 can provide the fulfillment request message, or a derivation thereof, to the one or more transporter user devices including the transporter user device 110.

At step 316, after receiving the fulfillment request message, the transporter of the transporter user device 110 can determine whether or not they want to perform the fulfillment. The transporter can decide that they want to perform the delivery of the one or more items from the service provider location to the end user location. The transporter user device 110 can generate an acceptance message that indicates that the fulfillment request is accepted.

At step 318, after generating the acceptance message, the transporter user device 110 can provide the acceptance message to the central server computer 102.

In some embodiments, after receiving the acceptance message, the central server computer 102 can notify the other transporter user devices that received the fulfillment request message that the fulfillment request is no longer available.

After providing the acceptance message to the central server computer 102, the transporter user device 110 can communicate with the navigation network 116 and the transporter can proceed to the service provider location to obtain the one or more items. The transporter user device 110 can then receive input from the transporter that indicates that the transporter obtained the one or more items (e.g., the transporter selects that they picked up the items). The transporter user device 110 can then communicate with the navigation network 116 and the transporter can then proceed to the end user location to provide the one or more items to the end user. In some embodiments, the transporter user device 110 can provide update messages to the central server computer 102 that include a transporter user device 110 location and/or event data (e.g., items picked up, items delivered, etc.).

At step 320, the transporter user device 110 can collect transporter location data at a regular interval and transmit it to the central server computer 102 throughout the delivery. In some embodiments, the intervals may be less than a minute long. For example, the transporter user device 110 may determine a location of the transporter every second and store the data point comprising the location of the transporter and the time in memory. Every five seconds, the transporter user device 110 can transmit a message comprising the five data points to the central server computer 102. The message may be transmitted over a cellular network provided by the mobile network operator of the transporter user device 110. This process can repeat throughout the transporter's shift and terminate once the shift has ended.

At any point after receiving the acceptance message, the central server computer 102 can check the status of the fulfillment request. For example, the central server computer 102 can determine the location of the transporter user device 110 and can determine an estimated amount of time for the transporter user device 110 to arrive at the end user location.

At step 322, the central server computer 102 can provide an update message to the end user device 108 that includes data related to the fulfillment of the fulfillment request message. The data can include an estimated amount of time, the transporter user device location, event data (e.g., items picked up from the service provider), and/or other data related to the fulfillment of the fulfillment request message.

At step 324, the central server computer 102 can store any data received, sent, and/or processed during the fulfillment of the fulfillment request message in a database. For example, the central server computer 102 can store a user's cart selection as user features into a user feature database.

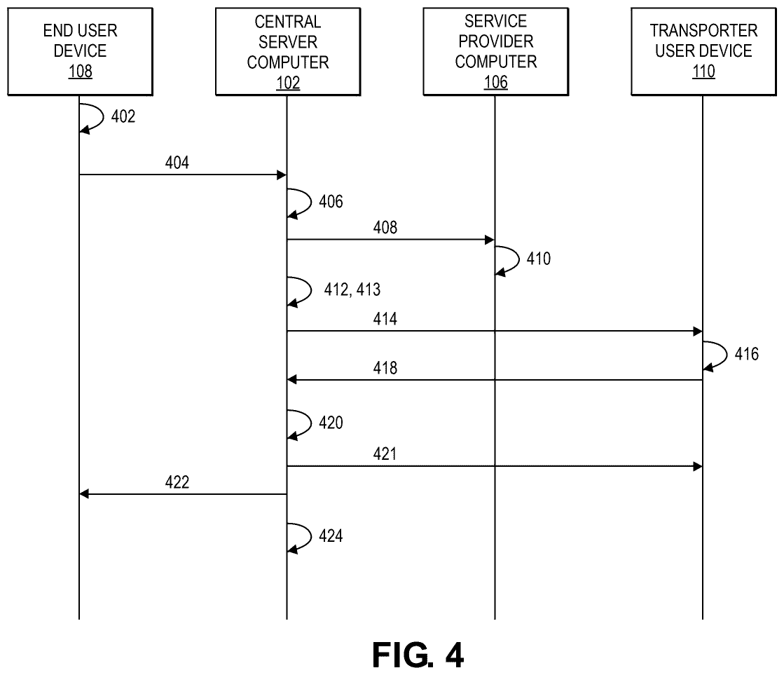

FIG. 4 shows a flow diagram illustrating a preparation and delivery method enhanced by a network connectivity map according to embodiments. As in FIG. 3, the method illustrated in FIG. 4 will be described in the context of the central server computer 102 receiving a fulfillment request message from the end user device 108 to fulfill preparation and delivery of one or more items from a cart to the end user of the end user device 108. The central server computer 102 can communicate with the service provider computer 106 and the transporter user device 110 to fulfill the fulfillment request.

Steps 402-410 respectively correspond with steps 302-310 of FIG. 3 and the descriptions thereof are incorporated herein.

At step 412, the central server computer 102 can determine a network connectivity map associated with the delivery route that the transporter operating the transporter user device 110 will take when transporting an item to the end user operating the end user device 108. The network connectivity map can comprise network connectivity ratings for the service provider location, the end user location, and the route associated with the delivery. The central server computer 102 can retrieve transporter data associated with a plurality of item deliveries. The transporter data may be historical transporter data collected using the method described in step 320 of FIG. 3. The central server computer may filter transporter data to obtain the transporter data that is related to the present item fulfilment request (e.g., transporter data from the same or similar service provider location, drop-off location, and/or delivery route). The transporter data can comprise time and location data of the transporter at time intervals as the transporters deliver items to end users.

The central server computer 102 can then create or obtain a network connectivity map based upon the transporter data. In some embodiments, the central server computer 102 can rate the addresses that are associated with the delivery (e.g., hotspots, drop-off location, pick-up location, delivery route). The addresses may be rated as supporting good network connectivity, poor network connectivity, or no network connectivity.

In some embodiments, step 412 can occur before step 402 or at any other suitable time. The central server computer 102 can create the network connectivity map in advance of any fulfillment requests by end users and store the network connectivity map in memory. Relevant portions of the connectivity map can be retrieved after a fulfillment request is received by the central server computer 102.

At step 413, after providing the fulfillment request message to the service provider computer 106, the central server computer 102 can determine one or more transporters operating one or more user devices that are capable of fulfilling the fulfillment request message. The central server computer 102 can determine the one or more transporters from the transporter user devices.

In some embodiments, the central server computer 102 can determine the one or more transporter user devices based on the network connectivity map. For example, the network connectivity map may exhibit that a first cellular network provided by a first mobile network operator has better network connectivity at the service provider location, the drop-off location, and throughout the delivery route. In determining the one or more transporter user devices, the central server computer 102 may prioritize the transporter user devices that use the first cellular network provided by the first mobile network operator. The central server computer 102 may also consider whether or not the transporter user device is online, whether or not the transporter user device is already fulfilling a different fulfillment request message, a location of the transporter user device, etc.

At step 414, after determining the one or more transporter user devices, the central server computer 102 can provide the fulfillment request message, or a derivation thereof, to the one or more transporter user devices including the transporter user device 110.

At step 416, after receiving the fulfillment request message, the transporter of the transporter user device 110 can determine whether or not they want to perform the fulfillment. The transporter can decide that they want to perform the delivery of the one or more items from the service provider location to the end user location. The transporter user device 110 can generate an acceptance message that indicates that the fulfillment request is accepted.

At step 418, after generating the acceptance message, the transporter user device 110 can provide the acceptance message to the central server computer 102.

In some embodiments, after receiving the acceptance message, the central server computer 102 can notify the other transporter user devices that received the fulfillment request message that the fulfillment request is no longer available.

After providing the acceptance message to the central server computer 102, the transporter user device 110 can communicate with the navigation network 116 and the transporter can proceed to the service provider location to obtain the one or more items. The transporter user device 110 can then receive input from the transporter that indicates that the transporter obtained the one or more items (e.g., the transporter selects that they picked up the items). The transporter user device 110 can then communicate with the navigation network 116 and the transporter can then proceed to the end user location to provide the one or more items to the end user. In some embodiments, the transporter user device 110 can provide update messages to the central server computer 102 that include a transporter user device 110 location and/or event data (e.g., items picked up, items delivered, etc.).

At step 420, at any point after receiving the acceptance message, the central server computer 102 can check the status of the fulfillment request. For example, the central server computer 102 can determine the location of the transporter user device 110 and can determine an estimated amount of time for the transporter user device 110 to arrive at the end user location. The central server computer 102 may also collect transporter data as described in step 320 of FIG. 3.

At step 421, in some embodiments, if the central server computer 102 anticipates that the transporter user device 110 is about to enter a location with poor network connectivity, the central server computer 102 can transmit a message based on the network connectivity map to the transporter user device 110. The central server computer 102 can use the network connectivity map to determine whether or not the transporter user device 110 is about to enter a location with poor network connectivity. The message may include any suitable information that can improve the transporter's ability to perform transportation services for the end user of the end user device 108.

In some embodiments, the central server computer 102 can transmit a second message to the transporter user device 110 while the transporter advances through the route. The second message can comprise one or more of the above-described messages. For example, the central server computer 102 can transmit a first message based on the network connectivity map immediately after the transporter accepts the fulfillment comprising the network connectivity for a plurality of locations along the first and second route. Once the transporter is about to enter one of the locations along the first or second route with poor or non-existent network connectivity, the central server computer 102 may also transmit a second message based on the network connectivity map to remind the transporter.

In some embodiments, the central server computer 102 can determine a first route from the transporter's current location to the service provider location and a second route from the service provider location to the end-user location. The central server computer 102 can use the network connectivity map to determine the network connectivity at one or more locations along the first route and the second route, and transmit it to the transporter user device 110. If any of the locations along the first route or second route have poor or no network connectivity, the message from the central server computer 102 can comprise a notification indicating that the transporter may have poor or no network connectivity at that location. Upon receiving the message based on the network connectivity map, the transporter may then expect that they may not receive communication from the central server computer 102 at that location.

In another embodiment, the message may also comprise code that causes the transporter application in the transporter user device 110 to improve communication between the transporter user device 110 and the central server computer 102. For example, at locations along the first route and/or the second route that the central server computer 102 has determined network connectivity may be weak or non-existent, the code may cause the transporter user device 110 to connect to a wireless network at the service provider location. This will allow the transporter user device 110 to communicate with the central server computer 102 even if the connectivity with the transporter's cellular network is poor or non-existent.

In another example, prior to the transporter entering a location with poor or non-existent network connectivity that, the central server computer 102 can prompt the transporter user device 110 to download navigation instructions. The central server computer 102 can transmit a message comprising code that triggers the transporter user device 110 to download navigation instructions while the transporter user device 110 can communicate with the transporter's cellular network. The downloaded navigational instructions can allow the transporter user device 110 to provide navigation instructions to the transporter even if the transporter user device has poor or no network connectivity with their cellular network.

At step 422, the central server computer 102 can provide an update message to the end user device 108 that includes data related to the fulfillment of the fulfillment request message. The data can include an estimated amount of time, the transporter user device location, event data (e.g., items picked up from the service provider), and/or other data related to the fulfillment of the fulfillment request message.

At step 424, the central server computer 102 can store any data received, sent, and/or processed during the fulfillment of the fulfillment request message into a database. For example, the central server computer 102 can store transporter data as features into a feature database.

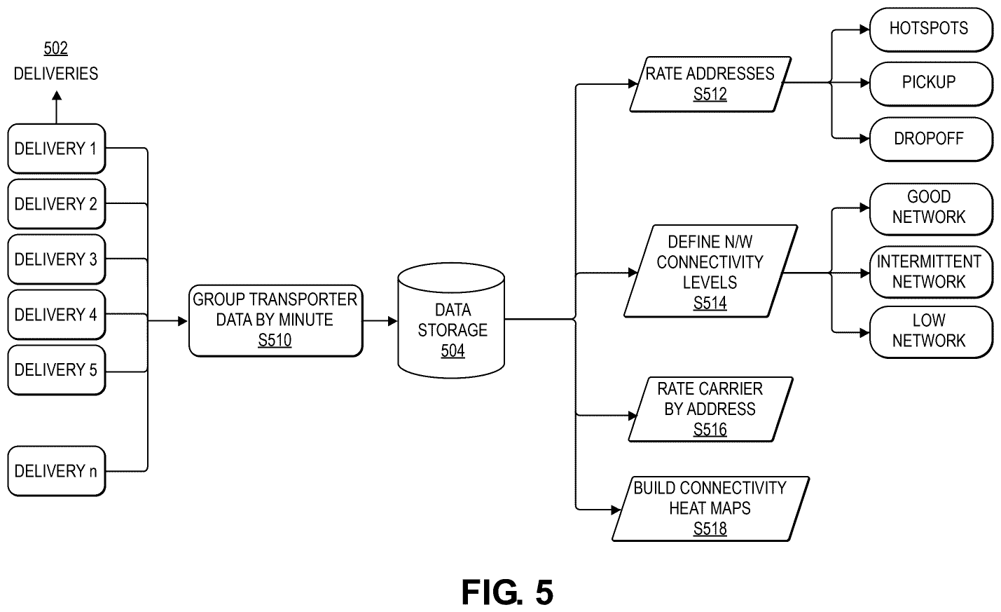

FIG. 5 shows a flow diagram illustrating transporter data collection and processing methods according to embodiments. The collection and processing methods can be performed by a central server computer in the context of the system as illustrated in FIG. 1.

At step S502, the central server computer can receive transporter data associated with a plurality of deliveries (e.g., delivery 1, delivery 2, . . . , delivery n), and group the transporter data. The raw transporter data can comprise location data, collected at regular intervals that are less than a minute long, of transporters from a plurality of deliveries. For an exemplary delivery method where transporter data is collected, see FIG. 3 and its description.

At step S510, the central server computer can perform an ETL (extract transform and load) job to sort the transporter location data of the plurality of deliveries. For each delivery in the plurality of deliveries, the transporter data may be collected using the method described in step 320 of FIG. 3. Each transporter data point can comprise a location point (e.g., latitude and longitude), a transporter identifier (e.g., a phone number), a mobile network operator identifier, a device type identifier, and a timestamp. The ETL job can disaggregate each delivery into multiple minutes, thus capturing a volume of transporter data points for every minute of every delivery. The ETL may be performed daily as new transporter data is collected. For example, if the central server computer received transporter location data from a transporter user device between 5:30 pm and 5:33 pm, the central server computer can organize the data into 3 buckets (e.g., 5:30 pm-5:31 pm, 5:31 pm-5:32 pm, and 5:32 pm-5:33 pm). The volume of transporter data points per minute can be the number of data points in each bucket. The grouped data can be stored in a data storage 504. If the transporter user device is in constant communication with the central server computer, then each of the groups would have at least one data point with the transporter user device's location and timestamp associated with that location. If connectivity is poor or non-existent, then one or more of the groups may not have any transporter data or may have small amounts of transporter data in them.

At step 512, the central server computer can rate a plurality of addresses. The central server computer can sort the transporter data based on address. For example, the central server computer can categorize transporter data based on the hotspot address (e.g., parking lot or other commonplace for transporter during a delivery), item pickup address, and/or item drop off address, as determined by the latitude and longitude of each transporter data point. Those addresses can be rated with respect to connectivity quality. To determine the connectivity of a given address, the central server computer may use transporter data that has the latitude and longitude of the given address. If the transporter data from that address consistently reflects high volumes of transporter data points per minute, the central server can determine that the given address has good network connectivity. Otherwise, if the transporter data from that address reflects inconsistent volumes of transporter data points per minute or no transporter data points per minute, the central server computer can determine that the given address has weak or nonexistent network connectivity. For example, if restaurant A received transporter data points for every transporter sent to that location within a week, and restaurant B received a small number of data points for the transporters sent to that location in the same week, the address of restaurant A could be rated “good network connectivity” while address of restaurant B could be rated “poor network connectivity.”

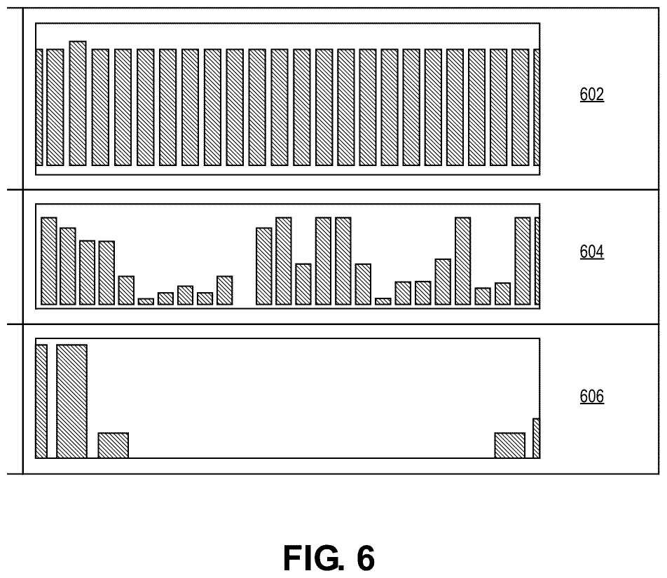

At step S514 the central server computer can determine a network connectivity map based on the transporter location data (e.g., the latitude and longitude of the transporter user device or the transporter) associated with many transporter user devices operated by many transporters performing transportation services. The network connectivity map can comprise network connectivity predictions for a plurality of addresses. The central server computer can define network connectivity levels for each location within a geographic area. For example, if a transporter is making a delivery and their transporter user device reports fewer transporter location data points per minute (see timeline 604 of FIG. 6), the location of the transporter may be an address with poor network connectivity. If the transporter location data points per minute is zero (see timeline 606 of FIG. 6), then there may be no network connection. In another example, a transporter may transport an item from location A with to location B. The transporter's location and time can be recorded by the central server computer at every location along the route from location A and location B. The same can be done for every other transporter user device in communication with the central server computer. The transporter data for each location, or lack thereof, along every route traversed by every transporter can be recorded and analyzed to determine the quality of the network connectivity for every location along every route.

During a delivery, the central server computer can use the network connectivity map of an area associated with the transportation to determine whether or not the transporter is likely to experience poor network connectivity. The area may comprise a service provider locations, end user locations, and route between them.

At step S516, since network connectivity is likely to vary based upon the mobile network operator, the central server computer can further sort the transporter data (such as described above in step S514) based on the mobile network operator of the transporter user device from which the transporter data was collected from. For example, transporter data collected from a first mobile network operator may be separated from transporter data collected from a second mobile network operator. Transporter data from transporter user devices that use the same mobile network operator can be associated with the same network connectivity map, whereas, the network connectivity map determined based on transporter data collected from the first mobile network operator may be separate from the network connectivity map determined based on transporter data collected from the second mobile network operator. This information can be used when the central server computer determines which transporter user device to transmit an item fulfilment request to, as described in step 413 of FIG. 4.

At step S518, the central server computer can build network connectivity heat maps. The network connectivity heat maps may be a useful visual tool to provide to both the transporter and end user. For example, the network connectivity heat map can be presented to the end user in order to prompt the end user ahead of time to provide navigational instructions or contact information for when the network connection becomes poor. The network connectivity heat map can be provided to the transporter upon accepting the item fulfilment request so that the transporter can prepare accordingly (e.g., look at navigation instructions ahead of time). The network heat map can show areas that are red, for example, where there is strong connectivity (e.g., a large percentage of communications are received from transporter user devices in the areas), and areas that are blue, for example, where there is weak connectivity (e.g., a small percentage of communications are received from transporter user devices in those areas).

FIG. 6 illustrates three timelines of transporter data reflecting varying network connection.

The transporter user device may be programmed to collect a transporter data point at regular time intervals and transmit it to the central server computer. The time intervals may be less than a minute long. To illustrate, the transporter user device can collect the transporter data every second, and transmit it to the central server computer. The central server computer can bin the transporter location data points into minute intervals, such that each bin should have 60 transporter location data points. When each bin consistently has 60 transporter location data points, it can be assumed that there is good network connectivity. Timeline 602 illustrates a time interval wherein the volume of transporter location data points is consistently high, which can indicate good network connectivity.

However, when there is weak or intermittent network connectivity, the transporter user devices may not be able to consistently report transporter location data points to the central server computer. Thus, poor network connectivity may be characterized by less than 60 transporter location data points per minute. Timeline 604 illustrates a time interval wherein the volume of transporter location data points is fluctuating, corresponding to a weak or intermittent network. In timeline 606, the transporter user device is not reporting any transporter location data points to the central server computer. This can indicate that there is no network connectivity.

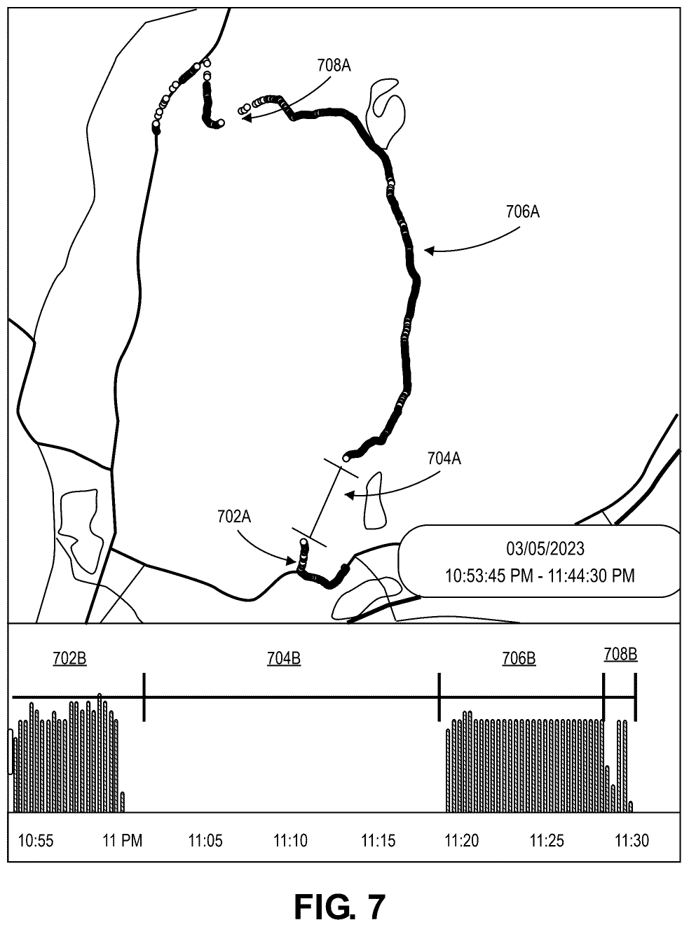

FIG. 7 shows transporter location data points overlaid on a map, and a corresponding timeline representing the volume transporter data points per minute. The transporter location data points may have been collected during a time interval in which the transporter was on a delivery route (e.g., driving to an item pickup or dropoff location).

The transporter location data points are segmented into portions: 702A, 704A, 706A, and 708A, which respectively correspond to three timeline segments 702B, 704B, 706B, and 708B.

Areas where the transporter location data is sparse may indicate that the transporter is traveling at a high speed or that the transporter location data is not being reported as expected. For example, the transporter location data path 702A is associated with regular volumes of transporter location data per minute as shown by the corresponding timeline segment 702B, which may be associated with good network connectivity. However, at 704A the transporter location data points stop, and hence the associated timeline segment 704B is empty. This is associated with no network connection. At this point, the transporter user device may have disconnected from the network. However, at 706A, the transporter location data points are received again, and the corresponding volumes of transporter location data in timeline segment 706B indicate good network connectivity. The network connectivity becomes weak or intermittent at 708A, which again is reflected by the dip in the timeline 708B of volumes of transporter location data per minute.

Embodiments of the disclosure have a number of technical advantages. By creating connectivity maps based upon transporter data, the connectivity maps produced by embodiments of the invention are more specific detailed and granular compared to connectivity maps produced by mobile network operators. The connectivity maps can be generated by crowdsourcing data from transporter end user devices and accurately depicts network connectivity in specific areas. By using the more accurate network connectivity maps according to embodiments, preemptive actions can be taken to ensure that a transporters transportation of an item or person is not impeded. Such preemptive actions can include sending a message that informs the transporter to expect low connectivity in a given area, a message that includes an instruction to connect to use another communication mechanism (e.g., Wi-Fi™) when the transporter is in the area of poor network connectivity, or a message that causes the transporter user device to download data (e.g., navigational instructions) that can be used when the transporter user device cannot communicate with a cellular network so that the transporters transportation operations are not impeded.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such devices. In addition, the order of operations may be re-arranged. A process can be terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Any operations performed with a processor (e.g., aligning, determining, comparing, computing, calculating) may be performed in real-time. The term “real-time” may refer to computing operations or processes that are completed within a certain time constraint. The time constraint may be 1 minute, 1 hour, 1 day, or 7 days. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The specific details of particular embodiments may be combined in any suitable manner without departing from the spirit and scope of embodiments of the disclosure. However, other embodiments of the disclosure may be directed to specific embodiments relating to each individual aspect, or specific combinations of these individual aspects.

The above description of example embodiments of the present disclosure has been presented for the purposes of illustration and description. It is not intended to be exhaustive or to limit the disclosure to the precise form described, and many modifications and variations are possible in light of the teaching above.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

The claims may be drafted to exclude any element which may be optional. As such, this statement is intended to serve as antecedent basis for use of such exclusive terminology as “solely,” “only,” and the like in connection with the recitation of claim elements, or the use of a “negative” limitation.

All patents, patent applications, publications, and descriptions mentioned herein are incorporated by reference in their entirety for all purposes. None is admitted to be prior art. Where a conflict exists between the instant application and a reference provided herein, the instant application shall dominate.

What is claimed is:

1. A method comprising:
receiving, by a server computer, transporter data associated with a plurality of transporters, wherein the transporter data comprises time and location data of the transporters at time intervals as the transporters move;
creating, by the server computer, a network connectivity map based upon the transporter data; and
storing, by the server computer, the network connectivity map.

2. The method of claim 1, further comprising:
receiving, by the server computer from an end user device operated by an end user, a fulfillment request message for an item provided by a service provider;
determining, by the server computer, one or more transporter user devices;
providing, by the server computer, the fulfillment request message to the one or more transporter user devices, wherein one or more transporters associated with the one or more transporter user devices determine whether or not to accept the fulfillment request message;
receiving, by the server computer, an acceptance message from a transporter user device of the one or more transporter user devices, the transporter user device associated with a transporter; and
transmitting, by the server computer, a message to the transporter user device, wherein the message is based on the network connectivity map.

3. The method of claim 2, wherein the message comprises information about network connectivity at one or more locations along a first route from a current location of the transporter and a location of the service provider or one or more locations along a second delivery route from the location of the service provider to a location of the end user.

4. The method of claim 2, wherein the message comprises code that causes a transporter application in the transporter user device to improve communication between the transporter user device and the server computer at locations where network connectivity is weak or non-existent along a first route from a current location of the transporter and a location of the service provider or one or more locations along a second route from the location of the service provider to a location of the end user.

5. The method of claim 2, wherein the message comprises code that causes a transporter application in the transporter user device to download navigation instructions prior to entering a location where network connectivity is weak.

6. The method of claim 2, wherein the determining, by the server computer, of the one or more transporter user devices is based on a mobile network operator of the transporter user device and the network connectivity map.

7. The method of claim 2, further comprising transmitting, by the server computer, a second message to the transporter user device, wherein the second message is based on the network connectivity map.

8. The method of claim 2, wherein the transporter user device is a mobile phone.

9. The method of claim 2, wherein each of the time intervals are less than a minute long.

10. The method of claim 2, wherein the fulfillment request message is associated with transportation of the item to the end user.

11. The method of claim 10, wherein the network connectivity map comprises network connectivity predictions for an area, the area comprising a service provider location, an end user location, and a route.

12. The method of claim 1, wherein the network connectivity map comprises ratings of network connections at a plurality of addresses.

13. The method of claim 1, wherein the transporter data is from transporter user devices that use a same mobile network operator.

14. A server computer comprising:
a processor; and
a non-transitory computer readable medium coupled to the processor, the non-transitory computer readable medium coupled to the processor, the non-transitory computer readable medium comprising code, executable by the processor for performing a method comprising:
receiving transporter data associated with a plurality of transporters, wherein the transporter data comprises time and location data of the transporters at time intervals as the transporters move;
creating a network connectivity map based upon the transporter data; and
storing the network connectivity map.

15. The server computer of claim 14, the method further comprising:
receiving, from an end user device operated by an end user, a fulfillment request message for an item provided by a service provider;
determining one or more transporter user devices;
providing the fulfillment request message to the one or more transporter user devices, wherein one or more transporters associated with the one or more transporter user devices determine whether or not to accept the fulfillment request message;
receiving an acceptance message from a transporter user device of the one or more transporter user devices; and
transmitting a message to the transporter user device, wherein the message is based on the network connectivity map.

16. The server computer of claim 15, wherein the message comprises information about cellular connectivity at one or more locations along a first route from a current location of the transporter and a location of the service provider or one or more locations along a second route from the location of the service provider to a location of the end user.

17. The server computer of claim 15, wherein the message comprises code that causes a transporter application in the transporter user device to improve communication with the transporter user device at locations where network connectivity is weak or non-existent along a pickup route from a current location of the transporter and a location of the service provider or one or more locations along a delivery route from the location of the service provider to a location of the end user.

18. The server computer of claim 15, wherein the message comprises code that causes a transporter application in the transporter user device to download navigation instructions prior to entering a location where network connectivity is weak.

19. The server computer of claim 15, wherein the fulfillment request message is associated with transportation the item to the end user.

20. The server computer of claim 19, wherein the network connectivity map comprises network connectivity predictions for an area, the area comprising a service provider location, an end user location, and a delivery route.
